(19) United States
(12) Patent Application Publication
(10) Pub. No.: US 2020/0269807 A1
(43) Pub. Date: Aug. 27, 2020

(54) INTEGRATION OF CHILD SAFETY SEAT WITH VEHICLE SEATBELT REMINDER SYSTEMS

(71) Applicant: Ford Global Technologies, LLC, Dearborn, MI (US)

(72) Inventor: Nathan Kristofor Tardif, Ferndale, MI (US)

(73) Assignee: Ford Global Technologies, LLC, Dearborn, MI (US)

(21) Appl. No.: 16/282,780

(22) Filed: Feb. 22, 2019

(51) Int. Cl. B60R 22/48; B60N 2/28; B60N 2/00

(52) U.S. Cl. CPC B60R 22/48; B60N 2/2893; B60R 2022/4816; B60N 2/002; B60N 2002/2815; B60N 2/2812

(57) ABSTRACT

An assembly includes a seat. The assembly includes a harness secured to the seat. The assembly includes a buckle supported by the harness. The assembly includes a buckle sensor supported by the buckle. The assembly includes a first clip secured to the seat and in electrical communication with the buckle sensor. The assembly includes a second clip secured to the seat and in electrical communication with the buckle sensor.

### BACKGROUND

Child seats are removable seats for seating and restraining children riding in a vehicle. Types of child seats include rearward-facing child seats, forward-facing child seats, combination seats that can face rearward or forward, and booster seats. Rearward-facing, forward-facing, and combination child seats include a harness for restraining the child occupant. Booster seats rely on the seatbelts included with the vehicle. Child seats may be held in place by the seatbelt of the vehicle and/or may include tethers for attaching to tether attachment brackets of the vehicle.

The vehicle may include a seatbelt minder system. The seatbelt minder system is typically configured to determine whether a seat of the vehicle is occupied and whether a seatbelt of such seat is fastened.

### BRIEF DESCRIPTION OF THE DRAWINGS

FIG. 1 is a perspective view of a child car seat installed in a vehicle.

FIG. 2A is a perspective view of the child car seat detached from and the vehicle.

FIG. 2B is a perspective view of the child car seat installed in the vehicle.

FIG. 2C is a perspective view of a portion of FIG. 2B.

FIG. 3 is a perspective view of an anchor and frame of the vehicle, and a clip of the child car seat engaged with the anchor.

FIG. 4 is a cross-section view of FIG. 3.

FIG. 5 is an electrical schematic of the child car seat installed in the vehicle.

FIG. 6 is a block diagram of components of the child car seat installed in the vehicle.

FIG. 7 is a flow chart for a process of controlling the vehicle with the installed child car seat.

### DETAILED DESCRIPTION

An assembly includes a seat. The assembly includes a harness secured to the seat. The assembly includes a buckle supported by the harness. The assembly includes a buckle sensor supported by the buckle. The assembly includes a first clip secured to the seat and in electrical communication with the buckle sensor. The assembly includes a second clip secured to the seat and in electrical communication with the buckle sensor.

The first clip and the second clip may be configured for attachment to an ISOFIX anchor of a vehicle.

The assembly may include a seat occupancy sensor supported by the seat and in electrical communication with the first clip and the second clip.

The seat occupancy sensor may include a first resistor and the buckle sensor may include a second resistor having a different electrical resistance than the first resistor.

The seat occupancy sensor may include a switch movable to a closed state in response to an application of a threshold amount of force to the seat.

The assembly may include a first latch plate and a second latch plate supported by the harness, and the buckle sensor may include a switch that is in a closed state when the first latch plate and the second latch plate are engaged with the buckle.

The switch may be in an open state when at least one of the first latch plate or the second latch plate are not engaged with the buckle.

An assembly includes a vehicle seat. The assembly includes a first anchor fixed relative to the vehicle seat. The assembly includes a second anchor fixed relative to the vehicle seat. The assembly includes a seat assembly supported by the vehicle seat. The seat assembly includes a buckle sensor, and a first clip and a second clip in electrical communication with the buckle sensor. The first clip is engaged with the first anchor and the second clip is engaged with the second anchor.

The assembly may include a vehicle frame, the first anchor and the second anchor electrically isolated from the vehicle frame.

The vehicle seat may include a seat bottom and a seat back, the first anchor and the second anchor between the seat bottom and seat back.

The assembly may include a vehicle computer, the vehicle computer in electrical communication with the first anchor and the second anchor and programmed to determine whether a buckle of the seat assembly is buckled based on information from the buckle sensor.

The seat assembly may include a seat occupancy sensor in electrical communication with the first clip and the second clip.

The assembly may include a vehicle computer, the vehicle computer in electrical communication with the first anchor and the second anchor and programmed to determine whether the seat assembly is occupied based on information from the occupancy sensor.

A system includes a processor and a memory storing instructions executable by the processor to identify an amount of electrical resistance between a first anchor engaged with a first clip of a seat assembly and a second anchor engaged with a second clip of the seat assembly. The instructions include instruction to determine a buckle status of the seat assembly based on the identified amount of electrical resistance.

The instructions may include instructions to actuate a vehicle component to provide notification upon determining that the buckle status is unbuckled based on the identified amount of electrical resistance.

The instructions may include instructions to determine an occupancy status of the seat assembly based on the identified amount of electrical resistance.

The instructions may include instructions to actuate a vehicle component to provide notification upon determining that the buckle status is unbuckled and that the occupancy status is occupied based on the identified amount of electrical resistance.

The system may include the first anchor and the second anchor, wherein the first anchor and the second anchor are in electrical communication with the processor.

The system may include a vehicle seat having a seat bottom and a seat back, the first anchor and the second anchor between the seat bottom and the seat back.

With reference to the Figures, wherein like numerals indicate like parts throughout the several views, an assembly 20 for securing a child in a vehicle 22 includes a vehicle seat 24. The assembly 20 includes a first anchor 26a fixed relative to the vehicle seat 24. The assembly 20 includes a second anchor 26b fixed relative to the vehicle seat 24. The assembly 20 includes a child seat assembly 28 supported by the vehicle seat 24. The child seat assembly 28 includes a seat 30. The child seat assembly 28 includes a harness 32 secured to the seat 30. The child seat assembly 28 includes a buckle 34 supported by the harness 32. The child seat assembly 28 includes a buckle sensor 36 supported by the buckle 34. The child seat assembly 28 includes a first clip 38a secured to the seat 30 and in electrical communication with the buckle sensor 36. The child seat assembly 28 includes a second clip 38b secured to the seat 30 and in electrical communication with the buckle sensor 36. The first clip 38a may be engaged with the first anchor 26a and the second clip 38b may be engaged with the second anchor 26b, e.g., when the child seat assembly 28 is installed in the vehicle 22. The engagement of the first clip 38a and the first anchor 26a, and the second clip 38b and the second anchor 26b, secures the child seat assembly 28 to the vehicle 22 and provides an electrical connection therebetween. The adjectives “first,” “second,” etc., are used throughout this document as identifiers and are not intended to signify importance or order.

The assembly 20 provides communication between sensors of the child seat assembly 28, such as the buckle sensor 36 and an occupancy sensor 40, and a computer 42 of the vehicle 22 via physical engagement of the clips 38a, 38b and anchors 26a, 26b. Such communication may be made without a specialized communication port, wireless communication hardware in the child seat assembly 28, etc.

The vehicle 22 may be any type of passenger or commercial automobile such as a car, a truck, a sport utility vehicle, a crossover vehicle, a van, a minivan, a taxi, a bus, etc. Front, rear, left and right sides, and other relative directions used herein may be relative to an orientation of controls for operating the vehicle 22, e.g., a steering wheel, etc. The front, rear, left and right sides, and relative directions used herein may be relative to a driving direction of the vehicle 22 when wheels of the vehicle 22 are all parallel with each other.

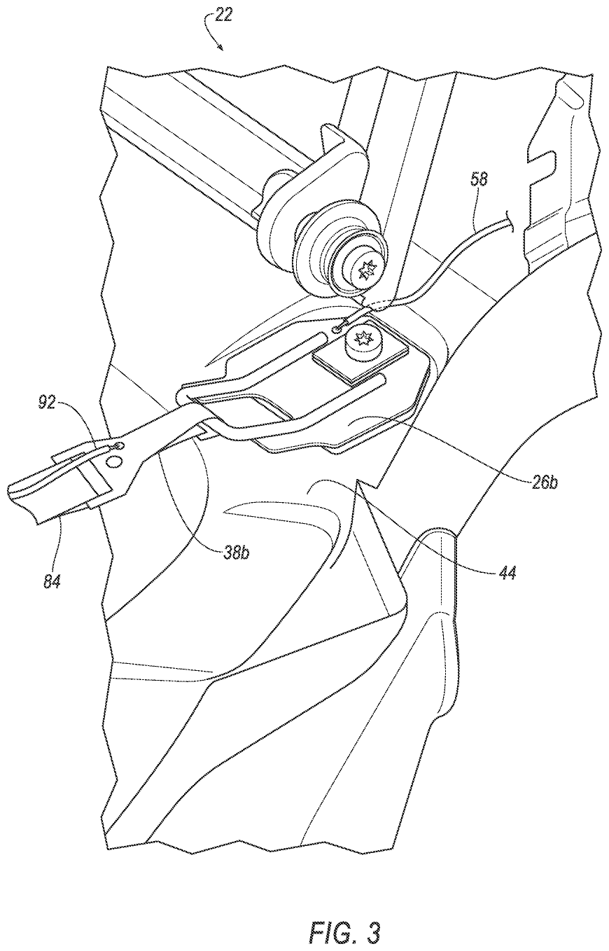

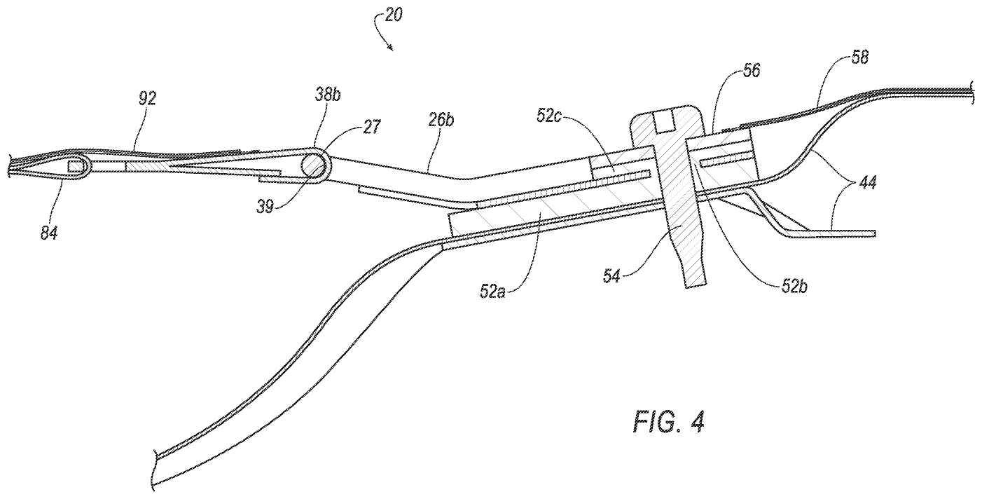

The vehicle 22 includes a frame 44, shown in FIGS. 3 and 4. The frame 44 may be of a unibody construction. In the unibody construction, a body of the vehicle 22, e.g., rockers, pillars, floor panels, etc., serves as the frame 44, and the body (including the rockers, pillars, roof rails, etc.) is unitary, i.e., a continuous one-piece unit. As another example, the vehicle 22 may have a body-on-frame construction (also referred to as a cab-on-frame construction). In other words, the body and frame 44 are separate components, i.e., are modular, and the body is supported on and affixed to the frame. Alternatively, the body and frame may have any suitable construction. The body and/or the frame 44 may be any suitable material, for example, steel, aluminum, etc.

The vehicle 22 includes a passenger cabin 46 to house occupants, if any, of the vehicle 22. The passenger cabin 46 includes one or more seats 24. The seat 24 is shown to be a bench seat, but the seat 24 may be other types. The seat 24 may include a seat back 48 and a seat bottom 50. The seat back 48 may be supported by the seat bottom 50 and may be stationary or movable relative to the seat bottom 50. The seat back 48 and/or the seat bottom 50 may be supported by the frame 44.

The first anchor 26a and the second anchor 26b enable physical attachment of the child seat assembly 28 to the vehicle 22. The first anchor 26a and the second anchor 26b are fixed relative to the vehicle seat 24. For example, the first anchor 26a and the second anchor 26b may be fixed to the frame 44 of the vehicle 22, e.g., with a fastener. As another example, the first anchor 26a and the second anchor 26b may be fixed to a frame of the seat 24. The first anchor 26a and the second anchor 26b may be configured to comply with ISOFIX (ISO 13216), the international standard for attachment points for child safety seats in passenger cars. ISOFIX may be referred to as LATCH (“Lower Anchors and Tethers for Children”) in the United States, LUAS (“Lower Universal Anchorage System”) or Canfix in Canada, and/or UCSSS (“Universal Child Safety Seat System”). For example, the first anchor 26a and the second anchor 26b may have a center-to-center distance of 280 millimeters. As another example, the first anchor 26a and the second anchor 26b may have a width of at least 25 millimeters. As one more example, the first anchor 26a and the second anchor 26b may have a diameter of 6 millimeters, with a tolerance of +/−0.1 millimeters. In addition to dimensional requirements, the first anchor 26a and the second anchor 26b may be designed to have a certain strength, e.g., to meet the ISOFIX standard.

The first anchor 26a and the second anchor 26b may be between the seat bottom 50 and seat back 48, e.g., such that the anchors 26a, 26b may be accessed by compressing a cushion of the seat back 48 and/or seat bottom 50. As another example, anchors 26a, 26b may be on the seat bottom 50 at the seat back 48, or vice versa.

The first anchor 26a and the second anchor 26b provide electrical communication with the child seat assembly 28. For example, the anchors 26a, 26b may include an electrically conductive material on a surface 27 (shown in FIG. 4) designed to contact the clips 38a, 38b of the child seat assembly 28 when installed in the vehicle 22. The anchors 26a, 26b may be electrically conducive material.

The first anchor 26a and the second anchor 26b are electrically isolated from the frame 44 such that electricity is inhibited from flowing therebetween. In other words, the first anchor 26a and the second anchor 26b are free from electrical connection to the frame 44 of the vehicle 22. For example, a non-electrically conductive gasket 52a, e.g., made of rubber, plastic, ceramic, etc., may be between each of the anchors 26a, 26b and the frame 44 of the vehicle 22. Another non-electrically conductive gasket 52b may be between the anchor 26a, 26b and a bolt 54 (or other fastener) fixing the anchor 26a, 26b to the frame 44, e.g., within an opening of the anchor. Another non-electrically conductive gasket 52c may be between the anchor 26a, 26b and a washer 56 on the bolt 54, e.g., opposite the frame 44. The gaskets 52a, 52b, 52c may be monolithic, i.e., a one-piece unit without any fasteners, joints, welding, adhesives, etc., fixing the gaskets 52a, 52b, 52c to each other.

The first anchor 26a and the second anchor 26b are in electrical communication with the computer 42. In other words, the computer 42 may receive data or other electrical information from the first anchor 26a and the second anchor 26b. For example, each anchor 26a, 26b may include a wire 58 operatively coupled to the anchor 26a, 26b, i.e., providing an electrical connection therebetween. The wires 58 may be operatively coupled to the anchors 26a, 26b via, solder, crimp or other compression type electrical connector, etc. The wires 58 may be connected to a communication network 60 of the vehicle 22, such as a vehicle bus, that is connected to the computer 42. The wires 58 may be connected via a sensor 62, such as an ohmmeter, that is connected to the computer 42, e.g., via the communication network 60.

The child seat assembly 28 is designed to control kinematics of a child, e.g., a human having a certain, age, height, weight, etc., during a vehicle collision. The child seat assembly 28 is configured for installation in the vehicle 22. The installed child seat assembly 28 is supported by the seat 24 of the vehicle 22. For example, the child seat assembly 28 may sit atop the seat bottom 50 and abut the seat back 48. The child seat assembly 28 may be installed in a forward-facing orientation, i.e., where the child seat assembly 28 faces a front of the vehicle 22. The child seat assembly 28 may be installed in a rearward-facing orientation, i.e., where the child seat assembly 28 faces a rear of the vehicle 22 (not shown).

The seat 30 of the child seat assembly 28 is designed to receive a child and support other components of the child seat assembly 28. The seat 30 may include a seat bottom 64 and a seat back 66, e.g., for a child to sit on and recline against. As another example, the seat 30 may support the harness 32, cushions, etc. The seat 30 may include a base 68 supporting the seat bottom 64 and seat back 66. The seat bottom 64 and seat back 66 may pivot relative to the base 68, e.g., to change an angle of the seat bottom 64 and seat back 66 of the child seat assembly 28 relative to the seat 24 of the vehicle 22 supporting the base 68.

The harness 32 of the child seat assembly 28 controls kinematics of a child in the seat 30, e.g., when the child seat assembly 28 is installed in the vehicle 22 and during an impact to the vehicle 22. The harness 32 may include multiple portions 70a, 70b, 70c, 70d, 70e of webbing 70 that are releasably securable to each other, e.g., via the buckle 34 and latch plates 72a, 72b. The portions 70a, 70b, may be designed to extends across shoulders and a chest of the child in the seat 30. The portions 70c, 70d may be designed to extends across hips of the child in the seat 30. The portion 70e may be designed to extend between legs of the child in the seat 30, e.g., to prevent “submarining” of the child during an impact to the vehicle 22.

The harness 32 is secured to the seat 30. For example, the webbing 70 may extend around the seat 30, though slots of the seat 30, may be sewn in a loop around a component of the seat 30, etc. The harness 32 may be secured to the seat 30 with a selectively engageable clamp that enables adjustment of a length of one or more portions 70a, 70b, 70c, 70d, 70e of the webbing 70, e.g., to adjust a size of the harness 32 to accommodate a size of the child in the seat 30.

The buckle 34 of the child seat assembly 28 selectively secures portions 70a, 70b, 70c, 70d, 70e of the webbing 70 relative to each other. For example, the buckle 34 may define a slot designed to receive one or more latch plates 72a, 72b supposed by the portions 70a, 70b, 70c, 70d. The buckle 34 may engage the latch plates 72a, 72b upon their insertion into the slot and restrict removal therefrom. The buckle 34 may include a button that, upon depression, disengages the buckle 34 from the latch plates 72a, 72b and permits removal of the latch plates 72a, 72b from the slot(s) of the buckle 34.

The buckle 34 is supported by the harness 32. For example, the buckle 34 may be fixed to the portion 70e of the webbing 70 designed to extend between legs of the child in the seat 30. The portion 70e may be sewn to itself and form a loop that extends through an opening in the buckle 34.

The latch plates 72a, 72b are designed to be received by and selectively engageable with the buckle 34. For example, the latch plates 7a, 72b may include an opening or other feature designed to engage with a latch of the buckle 34. The latch plates 72a, 72b are supported by the harness 32. For example, a first latch plate 72a may be slideably secured to the portions 70a, 70c of the webbing 70 that extend along the shoulders, chest, and, hips on one side (such as a left side) of the child in the seat 30, i.e., such that the first latch plate 72a may slide along a length of the portions 70a, 70c and be inhibited from moving away from the portions 70a, 70c. A second latch plate 72b may be slideably secured to the portions 70b, 70d of the webbing 70 that extend along the shoulders, chest, and, hips on another side (such as a right side) of the child in the seat 30.

The clips 38a, 38b of the child seat assembly 28 secure the child seat assembly 28 to, and provide electrical communication with, the vehicle 22 via the anchors 26a, 26b. The clips 38a, 38b may include an open loop and flexible gate, the clips 38a, 38b may be “alligator” style defining a slot with a button actuated latch (not shown), etc. The clips 38a, 38b may be configured for attachment to an anchor that meets ISOFIX standards. For example, the clips 38a, 38b may be configured to received and selectively engage an anchor having a certain diameter, e.g., 6 millimeters, with a tolerance of +/−0.1 millimeters. As another example, the clips 38a, 38b may have widths, e.g., of latches or other portions of the clips 38a, 38b that selectively engage the anchors 26a, 26b, that are less than a certain amount, e.g., 25 millimeters.

The first clip 38a and the second clip 38b are secured to the seat 30 of the child seat assembly 28, e.g., via webbing 84. The webbing 84 may be supported by and extend away from the seat 30. The webbing 84 may extend through openings of the seat 30. The webbing 84 may be looped around components of the seat 30 and sewn to itself. The first clip 38a and/or the second clip 38b may be fixed to a distal end of the webbing 84. For example, a loop may be sewn at the distal end and extend through an opening of one of the clips 38a, 38b. As another example, the first clip 38a and/or the second clip 38b may be slideably secured to the webbing 84. The first clip 38a and/or the second clip 38b may include a bar or other structure designed to inhibit movement of the clip 38a, 38b along the webbing 84 under specific loading conditions.

The first clip 38a and the second clip 38b provide electrical communication with the vehicle 22. For example, clips 38a, 38b may include an electrically conductive material on a surface 39 (shown in FIG. 4) designed to contact anchors 26a, 26b of the vehicle 22 when the child seat assembly 28 is installed in the vehicle 22. The clips 38a, 38b may be electrically conductive material, in whole or in part.

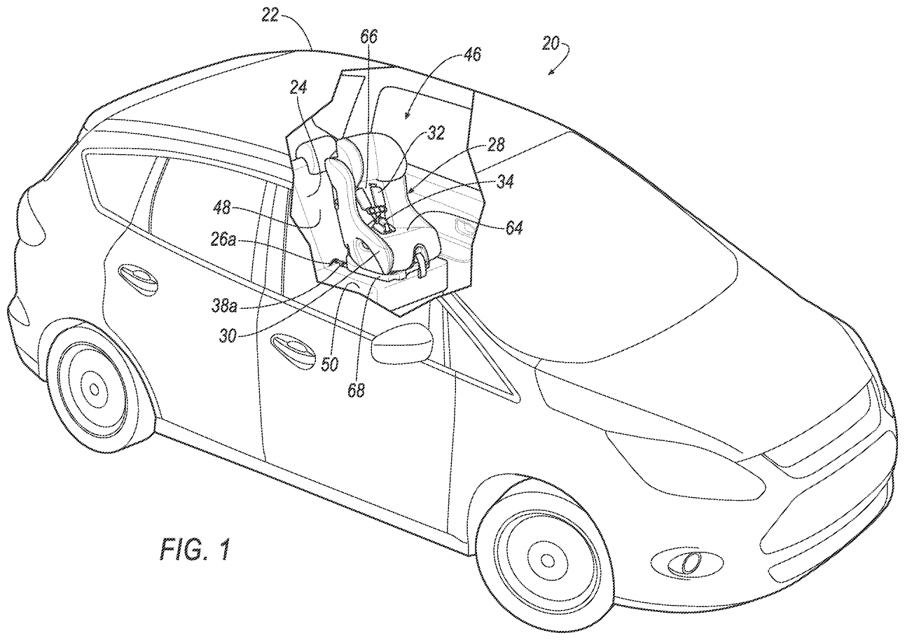

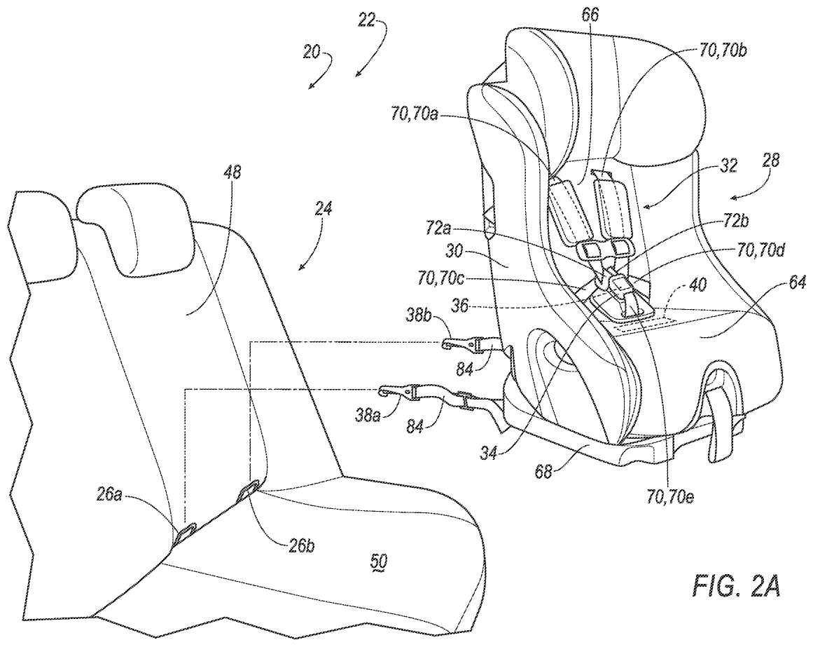

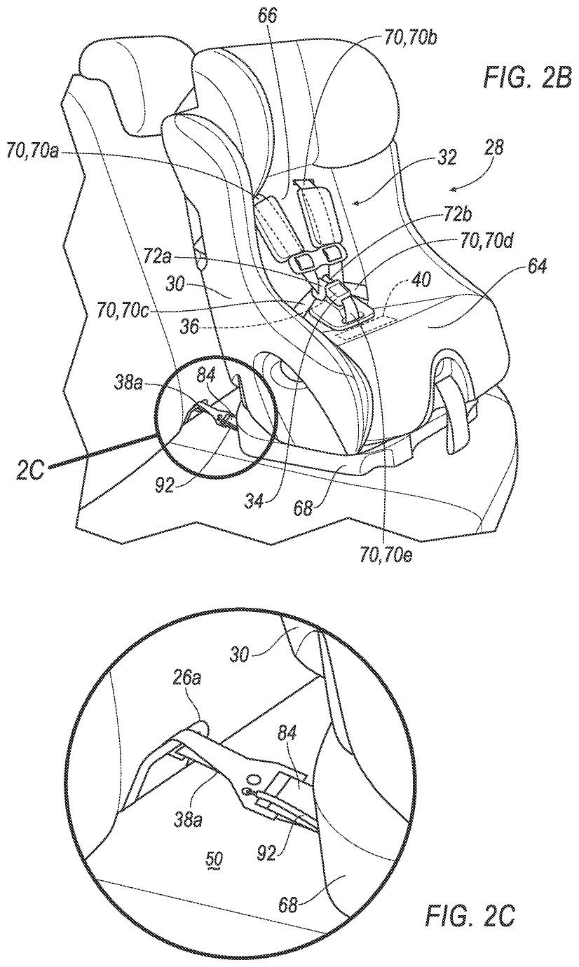

The first clip 38a and the second clip 38b are engaged with the first anchor 26a and the second anchor 26b when the child seat assembly 28 is installed in the vehicle 22, as shown in FIGS. 1 and 2B-4. The clips 38a, 38b may engage the anchors 26a, 26b by enclosing portions of the anchors 26a, 26b within the clips 38a, 38b. Electrically conductive material of the clips 38a, 38b abuts the conductive material of the anchors 26a, 26b while the clips 38a, 38b are engaged with the anchors 26a, 26b, i.e., such that an electrical connection is established therebetween.

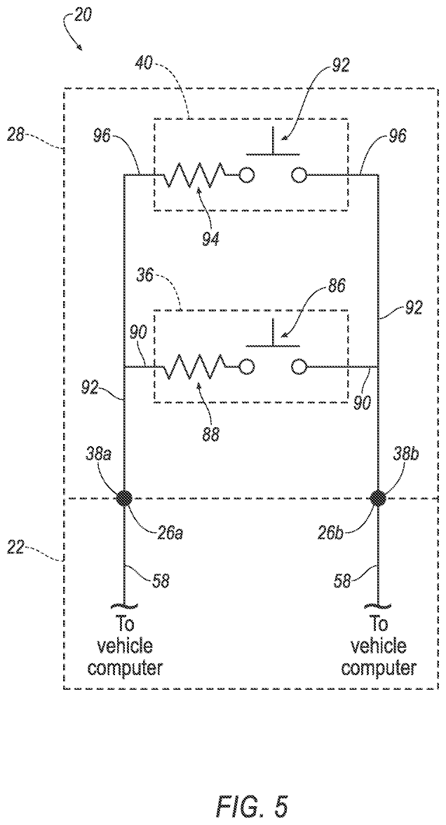

The buckle sensor 36 of the child seat assembly 28 detects whether the latch plates 72a, 72b are engaged with the buckle 34. The buckle sensor 36 is supported by the buckle 34. For example, the buckle sensor 36 may include a contact switch 86 and a resistor 88 connected in series between terminals 90 of the buckle sensor 36, as shown in FIG. 5. The switch 86 may be in a closed state providing electrical communication between the terminals 90 when both of the latch plates 72a, 72b are engaged with buckle 34. The switch 86 may be in an open state inhibiting electrical communication between the terminals 90 when at least one of the first latch plate 72a or the second latch plate 72b are not engaged with the buckle 34. The buckle sensor 36 may include other structures and sensors configured to detect when the latch plates 72a, 72b are engaged with the buckle 34, e.g., proximity sensors, hall effect sensors, etc.

The buckle sensor 36 is in electrical communication with the first clip 38a and the second clip 38b. For example, a wire 92 may connect one of the terminals 90 of the buckle sensor 36 to the first clip 38a, and another wire 92 may connect the other terminal 90 of the buckle sensor 36 to the second clip 38b. The wires 92 may be operatively coupled to the clips 38a, 38b, i.e., providing an electrical connection therebetween. The wires 92 may be operatively coupled to the clips 38a, 38b via, solder, crimp or other compression type electrical connector, etc.

The child seat assembly 28 may include the occupancy sensor 40. The occupancy sensor 40 detects whether the seat 30 is occupied. The occupancy sensor 40 is supported by the seat 30, e.g., by the seat bottom 64. The occupancy sensor 40 may include a contact switch 92 and a resistor 94 connected in series between terminals 96 of the occupancy sensor 40. The switch 92 may be in a closed state providing electrical communication between the terminals 96 in response to an application of a threshold amount of force to the seat 30. The switch 92 may be in an open state inhibiting electrical communication between the terminals 96 when less than the threshold amount of force is applied to the seat 30. The threshold amount of force may be selected based on a weight of a child to be supported by the seat 30, e.g., the threshold may be 5 lbs. The resistor 94 of the occupancy sensor 40 may provide a different amount of electrical resistance than the resistor 88 of the buckle sensor 36. For example, the resistor 94 of the occupancy sensor 40 may provide 10 ohms of electrical resistance, and the resistor 88 of the buckle sensor 36 may provide 20 ohms of electrical resistance. The occupancy sensor 40 may include other structures and sensors configured to detect when the seat 30 is occupied, e.g., proximity sensors, weight sensors, etc.

The occupancy sensor 40 is in electrical communication with the first clip 38a and the second clip 38b. For example, the wires 92 may connect the terminals 96 of the occupancy sensor 40 to the first clip 38a and the second clip 38b. The occupancy sensor 40 and the buckle sensor 36 may be connected in parallel, as shown in FIG. 5.

The vehicle 22 may include sensors 62. The sensors 62 may detect internal states of the vehicle 22, for example, wheel speed, wheel orientation, and engine and transmission variables. The sensors 62 may detect an amount of electrical resistance between the first anchor 26a and the second anchor 26b, e.g., an ohmmeter. The sensors 62 may detect the position or orientation of the vehicle 22, for example, global positioning system (GPS) sensors; accelerometers such as piezo-electric or microelectromechanical systems (MEMS) sensors; gyroscopes such as rate, ring laser, or fiber-optic gyroscopes; inertial measurements units (IMU); and magnetometers. The sensors 62 may detect the external world, for example, radar sensors, scanning laser range finders, light detection and ranging (LIDAR) devices, and image processing sensors such as cameras. The sensors 62 may include communications devices, for example, vehicle-to-infrastructure (V2I) or vehicle-to-vehicle (V2V) devices.

A user interface 98 presents information to and receives information from an occupant of the vehicle 22. The user interface 98 may be located, e.g., on an instrument panel in the passenger cabin 46 of the vehicle 22, or wherever may be readily seen by the occupant. The user interface 98 may include dials, digital readouts, screens such as a touch-sensitive display screen, speakers, and so on for providing information to the occupant, e.g., human-machine interface (HMI) elements. The user interface 98 may include buttons, knobs, keypads, microphone, and so on for receiving information from the occupant.

The communication network 60 includes hardware, such as a communication bus, for facilitating communication among vehicle components. The communication network 60 may facilitate wired or wireless communication among the vehicle components in accordance with a number of communication protocols such as controller area network (CAN), Ethernet, WiFi, Local Interconnect Network (LIN), and/or other wired or wireless mechanisms.

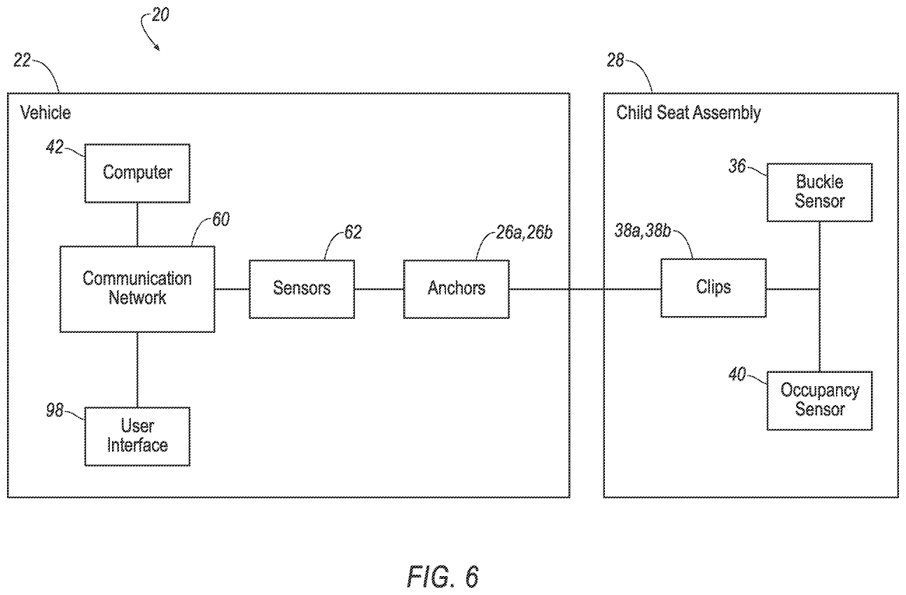

The computer 42, implemented via circuits, chips, or other electronic components, is included in the vehicle 22 for carrying out various operations, including as described herein. The computer 42 is a computing device that generally includes a processor and a memory, the memory including one or more forms of computer-readable media, and storing instructions executable by the processor for performing various operations, including as disclosed herein. The memory of the computer 42 further generally stores remote data received via various communications mechanisms; e.g., the computer 42 is generally configured for communications on a controller area network (CAN) bus or the like, and/or for using other wired or wireless protocols, e.g., Bluetooth, etc. The computer 42 may also have a connection to an onboard diagnostics connector (OBD-II). Via the communication network 60 using Ethernet, WiFi, the CAN bus, Local Interconnect Network (LIN), and/or other wired or wireless mechanisms, the computer 42 may transmit data and messages to various devices in the vehicle 22 and/or receive data and messages from the various devices. For example, the computer 42 is in electrical communication to receive data from the sensors 62, via the anchors 26a, 26b, etc. Although one computer 42 is shown in FIG. 6 for ease of illustration, it is to be understood that the computer 42 could include, and various operations described herein could be carried out by, one or more computing devices.

The computer 42 is programmed to, i.e., the memory of the computer 42 stores instructions executable by the processor to, determine whether the buckle 34 of the child seat assembly 28 is buckled based on information from the buckle sensor 36, e.g., received via the engagement of the clips 38a, 38b to the anchors 26a, 26b. For example, the computer 42 may identify an amount of electrical resistance between the first anchor 26a and the second anchor 26b, e.g., based on data from the sensors 62. The computer 42 may determine a buckle status of the child seat assembly 28, i.e., whether the buckle 34 is buckled or unbuckled, based on the identified amount of electrical resistance. Based on the identified amount of resistance the computer 42 may determine that the buckle 34 is buckled, i.e., that the latch plates 72a, 72b are engaged with the buckle 34. Based on the amount of resistance the computer 42 may determine that the buckle 34 is not buckled, i.e., that at least one of the latch plates 72a, 72b are not engaged with the buckle 34. The computer 42 may determine the buckle status by comparing the identified resistance to various resistance amounts stored in memory of the computer 42 and associated with the buckle statuses, e.g., in a look-up table or the like (described further below).

The computer 42 may be programmed to determine whether the child seat assembly 28 is occupied based on information from the occupancy sensor 40, e.g., received via the engagement of the clips 38a, 38b to the anchors 26a, 26b. The computer 42 may determine an occupancy status of the child seat assembly 28, i.e., that the child seat assembly 28 is occupied or not occupied, based on the identified amount of electrical resistance between the first anchor 26a and the second anchor 26b. The computer 42 may determine the occupancy status by comparing the identified resistance to various resistance amounts stored in memory of the computer 42 and associated with occupancy statuses, e.g., in a look-up table or the like (described further below).

The computer 42 may be programmed to actuate a vehicle component, such as the user interface 98, to provide notification, e.g., to an occupant of the vehicle 22, upon determining that the buckle status is unbuckled and upon determining that the occupancy status is occupied, e.g., based on the identified resistance. The computer 42 may actuate the user interface 98 by transmitting a command to the user interface 98 via the communication network 60 and including data specifying the notification. For example, the look up table may include notifications associated with various resistances, buckle statuses, and occupancy statuses. As example lookup table is provided below and populated based on a child seat assembly 28 having a buckle sensor 36 with a 10-ohm resistor and an occupancy sensor 40 with a 20-ohm sensor.

TABLE 1

| Identified | Buckle and | Notification |
|---|---|---|
| Resistance | Occupancy Status | to Provide |
| 0 | Unbuckled & Not Occupied | None |
| 10 | Buckled & Not Occupied | None |
| 20 | Unbuckled & Occupied | Unbuckled Warning |
| 6.7 | Buckled & Occupied | Buckled Occupant Confirmation |

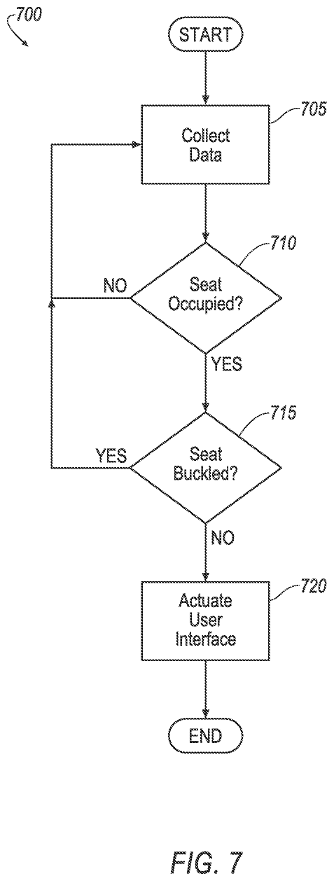

FIG. 7 is a process flow diagram illustrating an exemplary process 700 for operating the assembly 20. The process 700 begins in a block 705 where the computer 42 collects data, e.g., from the sensors 62, the occupancy sensor 40, the buckle sensor 36, etc., via the communication network 60, the engagement of the clips 38a, 38b and the anchors 26a, 26b, etc.

Next, at a block 710 the computer 42 determines whether the child seat assembly 28 is occupied, e.g., based on data from the occupancy sensor 40 of the child seat assembly 28 received via the engagement of the clips 38a, 38b and the anchors 26a, 26b. For example, the computer 42 may determine whether the child seat assembly 28 is occupied based on a detected resistance across the first anchor 26a and the second anchor 26b, e.g., as described above. Upon determining the child seat assembly 28 is not occupied the process 700 returns to the block 705. Upon determining the child seat assembly 28 is occupied the process 700 moves to a block x15.

At the block 715 the computer 42 determines whether the buckle 34 of the child seat assembly 28 is buckled, e.g., based on data from the buckle sensor 36 of the child seat assembly 28 received via the engagement of the clips 38a, 38b and the anchors 26a, 26b. For example, the computer 42 may determine whether the buckle 34 of the child seat assembly 28 is buckled based on a detected resistance across the first anchor 26a and the second anchor 26b, e.g., as described above. Upon determining the child seat assembly 28 is buckled the process 700 returns to the block 705. Upon determining the child seat assembly 28 is not buckled the process 700 moves to a block 720.

At the block 720 the computer 42 actuates the user interface 98 to provide notification that the buckle 34 is not buckled, e.g., as described above. After the block 720 the process 700 may end. Alternately, the process 700 may return to the block 705.

With regard to the process 700 described herein, it should be understood that, although the steps of such process 700 have been described as occurring according to a certain ordered sequence, such process 700 could be practiced with the described steps performed in an order other than the order described herein. It further should be understood that certain steps could be performed simultaneously, that other steps could be added, or that certain steps described herein could be omitted. In other words, the description of the process 700 herein is provided for the purpose of illustrating certain embodiments and should in no way be construed so as to limit the disclosed subject matter.

Computing devices, such as the computer 42, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Python, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, computing modules, etc.), stored on computer readable media associated therewith (e.g., disks, memories, etc.). A computer program product may comprise such instructions stored on computer readable media for carrying out the functions described herein.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. An assembly, comprising:
a seat;
a harness secured to the seat;
a buckle supported by the harness;
a buckle sensor supported by the buckle;
a first clip secured to the seat and in electrical communication with the buckle sensor; and
a second clip secured to the seat and in electrical communication with the buckle sensor.

2. The assembly of claim 1, wherein the first clip and the second clip are configured for attachment to an ISOFIX anchor of a vehicle.

3. The assembly of claim 1, further comprising a seat occupancy sensor supported by the seat and in electrical communication with the first clip and the second clip.

4. The assembly of claim 3, wherein the seat occupancy sensor includes a first resistor and the buckle sensor includes a second resistor having a different electrical resistance than the first resistor.

5. The assembly of claim 3, wherein the seat occupancy sensor includes a switch movable to a closed state in response to an application of a threshold amount of force to the seat.

6. The assembly of claim 1, further comprising a first latch plate and a second latch plate supported by the harness, and wherein the buckle sensor includes a switch that is in a closed state when the first latch plate and the second latch plate are engaged with the buckle.

7. The assembly of claim 6, wherein the switch is in an open state when at least one of the first latch plate or the second latch plate are not engaged with the buckle.

8. An assembly comprising:
a vehicle seat;
a first anchor fixed relative to the vehicle seat;
a second anchor fixed relative to the vehicle seat; and
a seat assembly supported by the vehicle seat, the seat assembly including a buckle sensor, and a first clip and a second clip in electrical communication with the buckle sensor;
the first clip engaged with the first anchor and the second clip engaged with the second anchor.

9. The assembly of claim 8, further comprising a vehicle frame, the first anchor and the second anchor electrically isolated from the vehicle frame.

10. The assembly of claim 8, wherein the vehicle seat includes a seat bottom and a seat back, the first anchor and the second anchor between the seat bottom and seat back.

11. The assembly of claim 8, further comprising a vehicle computer, the vehicle computer in electrical communication with the first anchor and the second anchor and programmed to determine whether a buckle of the seat assembly is buckled based on information from the buckle sensor.

12. The assembly of claim 8, wherein the seat assembly includes a seat occupancy sensor in electrical communication with the first clip and the second clip.

13. The assembly of claim 12, further comprising a vehicle computer, the vehicle computer in electrical communication with the first anchor and the second anchor and programmed to determine whether the seat assembly is occupied based on information from the occupancy sensor.

14. A system, comprising:
a processor; and
a memory storing instructions executable by the processor to:
identify an amount of electrical resistance between a first anchor engaged with a first clip of a seat assembly and a second anchor engaged with a second clip of the seat assembly; and
determine a buckle status of the seat assembly based on the identified amount of electrical resistance.

15. The system of claim 14, wherein the instructions include instructions to actuate a vehicle component to provide notification upon determining that the buckle status is unbuckled based on the identified amount of electrical resistance.

16. The system of claim 14, wherein the instructions include instructions to determine an occupancy status of the seat assembly based on the identified amount of electrical resistance.

17. The system of claim 16, wherein the instructions include instructions to actuate a vehicle component to provide notification upon determining that the buckle status is unbuckled and that the occupancy status is occupied based on the identified amount of electrical resistance.

18. The system of claim 14, further comprising the first anchor and the second anchor, wherein the first anchor and the second anchor are in electrical communication with the processor.

19. The system of claim 18, further comprising a vehicle seat having a seat bottom and a seat back, wherein the first anchor and the second anchor are between the seat bottom and the seat back.
